(19) United States
(12) Patent Application Publication
(10) Pub. No.: US 2017/0121554 A1
(43) Pub. Date: May 4, 2017

(54) WATER-BASED COATING COMPOSITION FOR USE IN A VARIETY OF SETTINGS

(71) Applicants: Ryan D. Richetti, Boca Raton, FL (US); Glenn Roberts, Boca Raton, FL (US)

(72) Inventors: Ryan D. Richetti, Boca Raton, FL (US); Glenn Roberts, Boca Raton, FL (US)

(21) Appl. No.: 14/925,772

(22) Filed: Oct. 28, 2015

(51) Int. Cl. C09D 133/14

(52) U.S. Cl. CPC C09D 133/14

(57) ABSTRACT

Embodiments described herein include methods for combining y-Glycidoxypropyltrimethoxysilane (GPTMS) and a Hydroxyl Functional Cationic Acrylic Solution Polymer to improve the durability, resistance, and adhesion of water based coatings. The polymer blend may contain; anatase titanium dioxide; rutile titanium dioxide; silicon dioxide nanoparticles, or carbon nanotubes.

### FIELD

The present embodiment relates to methods for combining y-Glycidoxypropyltrimethoxysilane (GPTMS) and a Hydroxyl Functional Cationic Acrylic Solution Polymer to improve the durability, resistance, and adhesion of water based coatings.

### BACKGROUND

The present embodiment relates to coating compositions based on aqueous dispersions of polymers, the compositions having utility in the formation of protective coatings for a variety of uses including paint primers, marine coatings, and other industrial coatings. Paint and other industrial coatings have traditionally contained lead and VOCs (volatile organic compounds). This has had a tremendous effect on human health, and lead was finally banned from use in the late 1970s. VOCs continue to be present in large quantities in solvent based coatings. Development of water based coatings began in the 1980s and today, water based coatings are used in a variety of fields, and eliminate or drastically reduce the presence of VOCs.

In the past, solvent-based coatings have been used to protect industrial surfaces as many water-based coatings have not been able to achieve results acceptable to the needs of industry standards. Historically, many industries have been hesitant to use water-based coatings until the technology improves. The advantages of these water based coatings include faster drying time, and greater resistance to environmental conditions. One notable disadvantage of water based coatings and epoxies is that they do not generally provide chemical resistance and adhesion comparable to solvent based coatings and epoxies. By improving the epoxy bond, this disadvantage can be overcome. Currently, there are several water based coating combinations used on the market. Specifically, U.S. Pat. No. 5,578,669 to Odawa; U.S. Pat. No. 4,459,326 to Colombo; U.S. Pat. No. 3,617,368 to Gibbs and U.S. Pat. No. 6,576,689 to Noda.

Though each of these references disclose certain aspects associated with water based coating durability, they are limited in their ability to achieve a bond that improves chemical and environmental resistance and adhesion to the surface.

### SUMMARY OF THE INVENTION

Embodiments described herein include a water-based coating composition for use in a variety of settings. The embodiments shown have the ability of providing a broad range of solid coatings which form a covalent bond between the Hydroxyl functional catactonic acrylic polymer to provide applications with greater durability, water intrusion, flexibility, and environmental resistance.

The present embodiment will demonstrate the effectiveness of y-Glycidoxypropyltrimethoxysilane, an epoxy, which bonds with a Hydroxyl Functional Cationic Acrylic Solution Polymer to improve the performance of water based coating systems. This will result in a lighter weight coating, easier application, faster drying time, faster chemical resistance achievement, and improved adhesion when faced with environmental conditions. The use of a water based coating will also have the effect of virtually eliminating VOCs.

An alternate embodiment enables the current embodiments shown to incorporate a third component. The alternate embodiment provides a further novel feature to the above shown mixture to provide aspects including: enhance strength and durability, self-cleaning, anti-biotic/anti-microbial. Further, the alternate embodiment may be incorporated to provide enhanced smart features, elasticity, and luminescence.

An even further embodiments provides a compound which combines the Glycidoxypropyltrimethoxysilane with a Hydroxyl Functional Cationic Acrylic Emulsion Polymer to create the embodiments shownherein.

Other aspects, advantages, and novel features of the present invention will become apparent from the following detailed description in conjunction with the drawings.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a glycidoxypropyltrimethoxysilane chemical molecule; and

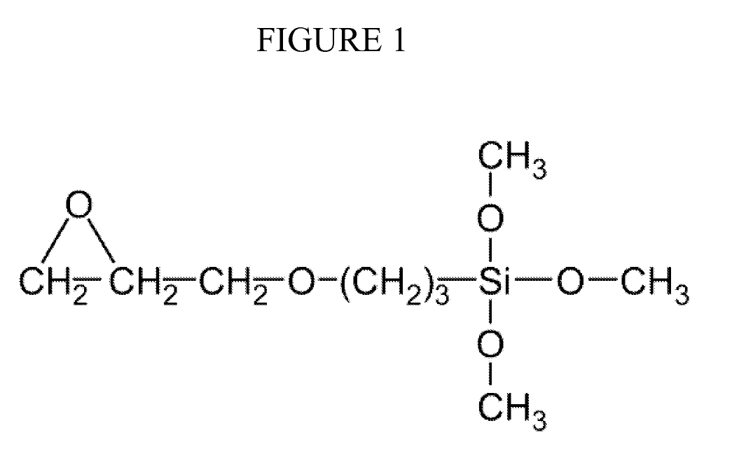

FIG. 2 is a perspective view of a hydroxyl functional acrylic polymer molecule block diagram of the apparatus.

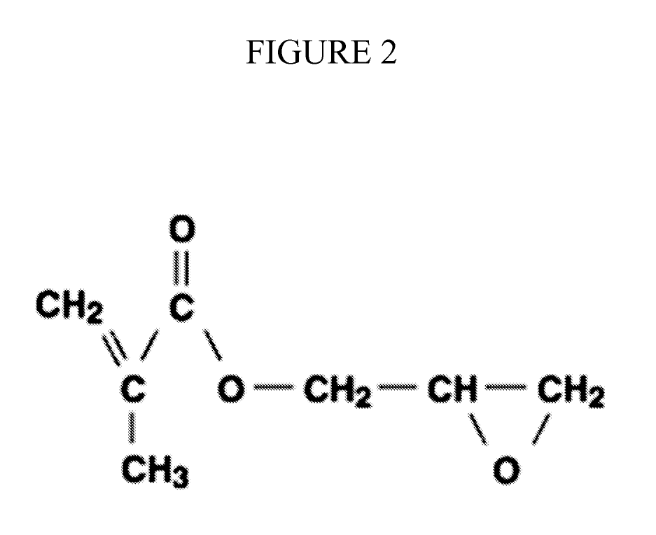

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

The present embodiment relates to methods for combining y-Glycidoxypropyltrimethoxysilane (GPTMS) and a Hydroxyl Functional Cationic Acrylic Solution Polymer to improve the durability, resistance, and adhesion of water based coatings. The molecular weight of the solution is at least 2000. The polymer blend may contain; anatase titanium dioxide; rutile titanium dioxide; silicon dioxide nanoparticles, or carbon nanotubes, which fortifies the acrylic and silane structure. This will form an interpenetrating polymer network that is a combination of two polymers in network form, at least one of which is synthesized and/or cross-linked in the immediate presence of the other. This has the effect of creating stronger structural and adhesive properties.

Glycidoxypropyltrimethoxysilane has a boiling point of 120 degrees Celsius, and a density of 1.070 g/mL at 20 degrees Celsius. The refractive index at 25 degrees Celsius is 1.428 to 1.430. Glycidoxypropyltrimethoxysilane is primarily used to enhance the cohesive sealants with water containing acrylic latex used in polyurethane and epoxy resin coatings.

The Hydroxyl Functional Cationic Acrylic Solution Polymer is used to create a durable, high-performance barrier suitable for chemical-resistant coatings. This provides aging stability and strong resistance to a plurality of solvents. The polymer crosslinks with polyisocyanates and epoxy silanes at 23 to 26 degrees Celsius. Further, an emulsion based variance (i.e., Hydroxyl Functional Cationic Acrylic Emulsion Polymer) may be crosslinked with Glycidoxypropyltrimethoxysilane to produce the embodiments discussed herein.

The polymer blend contains: 50 to 90 percent of a hydroxyl functional acrylic material; 0.5 to 30 percent glycidoxypropyltrimethoxysilane; 0.1 to 10 percent water-insoluble based ionic material.

Glycidoxypropyltrimethoxysilane can be substituted for a plurality of the following in the combination: Aminopropyltriethoxysilane; Aminoethylaminopropyltrimethoxysilane; Aminoethylaminopropyltrimethoxysilane (high purity); Aminoethylaminopropylsiloxane oligomers (aq); Aminoethylaminopropyltrimethoxysilane; Benzylated-aminoethylaminopropyltrimethoxysilane; y-Methacryloxypropyltrimethoxysilane; y-Chloropropyltrimethoxysilane; y-Chloropropyltriethoxysilane; Vinyltrimethoxysilane; Vinyltriacetoxysilane; Mercaptopropyltriethoxysilane; Disulfido Ethoxy; Bis-(triethoxysilylpropyl)-disulfide; Tetrasulfido Ethoxy Bis-(triethoxysilylpropyl)-tetrasulfide; y-Ureidopropyltriethoxysilane; Methoxy Epoxy silane; modified melamine resin;

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the following claims.

What is claimed is:

1. A water-based coating system for use in a variety of settings, comprising:
between 50 and approximately 95 weight percent based on the total weight of polymers used of an essential hydroxyl functional acrylic material; and
between 50 and approximately 95 weight percent on the total weight of C₉H₂₀O₅Si.

2. The composition of claim 1, further including about 0.5 to 30 weight percent based on the weight of a second C₉H₂₀O₅Si with a molecular weight of 236.34 which has a solubility in a plurality of water and oil-based products with an aqueous dispersion of at least 1 weight percent at the temperature of the polymer.

3. The composition of claim 1, further including 0.1 to 10 weight percent based on the total weight of polymer used in a plurality of water-soluble based ionic material which is selected from a group of polymers with a density of approximately 1.07 g/mL at 25 degrees Celsius.

4. The composition of claim 1, further including a refractive index of n20/D 1.429 (lit.) and solids of 29-41%.

5. The composition of claim 4, wherein a solution includes a boiling point of at least 120° C./2 mmHg (lit.).

6. The composition of claim 1, wherein the coated solution is selected from a group consisting of hydroxyl functional a catatonic acylic, and glycidoxypropyltrimethoxysilane molecules configured to graft the trimethoxy group onto the polymer.

7. A water-based coating system for use in a variety of setting, comprising:
at least 0.5 to 50 weight percentage of Glycidoxypropyltrimethoxysilane; and
at least 0.5 to 50 weight percent of hydroxyl functional cationic acrylic solution polymer in chemical communication with Glycidoxypropyltrimethoxysilane configured to form a impenetrable composite.

8. The composition of claim 7, wherein the solution forms a photo catalytically coating with a viscoscity of 300-800 cps.

9. The composition of claim 7, wherein the reaction of the Glycidoxypropyltrimethoxysilane and hydroxyl functional cationic acrylic react to form a hydroxyl functional polymer.

10. The composition of claim 9, wherein the Glycidoxypropyltrimethoxysilane is derived from an epoxy silane class.

11. The composition of claim 7, wherein the hydroxyl functional cationic acrylic will crosslink with at a polyisocyanates at 23 to 26 degrees Celsius.

12. The composition of claim 11, wherein the molecular weight is at least 2,000 and specific gravity of 1.042.

13. The composition of claim 12, wherein the curable composition comprises at least one polysiloxanes which reacts with at least one UV group to cure under radiation.

14. The composition of claim 13, wherein a radical is a hydroxyl functional polymer.
